(19) United States
(12) Patent Application Publication
(10) Pub. No.: US 2005/0142487 A1
(43) Pub. Date: Jun. 30, 2005

(54) Polymerizable adamantane derivative, production process thereof and polymeric compound

(75) Inventors: Hiroshi Koyama, Himeji-shi (JP); Kiyoharu Tsutsumi, Himeji-shi (JP)

Correspondence Address: BIRCH STEWART KOLASCH & BIRCH, PO BOX 747, FALLS CHURCH, VA, 22040-0747, US

(73) Assignee: Daicel Chemical Industries, Ltd.

(21) Appl. No.: 11/062,459

(22) Filed: Feb. 22, 2005

(30) Foreign Application Priority Data
Jul. 14, 2003 (JP) 2003-273943

(51) Int. Cl. G03C 1/76

(52) U.S. Cl. 430/270.1

(57) ABSTRACT

A polymerizable adamantane derivative of the present invention is represented by the following formula (1): 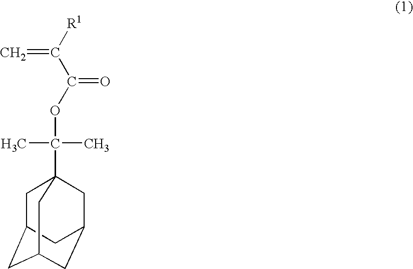
wherein R¹ is a fluorine atom or a fluoroalkyl group; and the adamantane ring in the formula may have a substituent. As the said fluoroalkyl group, there may be mentioned, for example, a trifluoromethyl, a pentafluoroethyl, a 2,2,2-trifluoroethyl, a 2,2,2-trifluoro-1-(trifluoromethyl)ethyl, a heptafluoropropyl group and so on.

### TECHNICAL FIELD

The present invention relates to an polymerizable adamantane derivative, which is useful as a monomer component of a photoresist resin used in a micro processing of semiconductor and others, to a production process therefore, and to a polymeric compound comprising a repeated unit corresponding to this monomer.

### BACKGROUND ART

An exposure-light source of lithography used in semiconductor manufacture becomes shorter wavelength year after year and is converted from KrF excimer laser with a wavelength of 248 nm to ArF excimer laser with a wavelength of 193 nm. F₂ excimer laser with a wavelength of 157 nm is hopefully focused as an exposure-light source of next generation. A conventional resin used in a resist for KrF excimer laser exposure and ArF excimer laser exposure doesn't show sufficient permeability to a vacuum ultraviolet light (a light with a wavelength of 190 nm or low). Some polymeric compounds having a fluorine atom in the molecule has been proposed as a resin with a high permeability to such a vacuum ultraviolet light (for example, Japanese Unexamined Patent Application Publication No. 2002-6501, Japanese Unexamined Patent Application Publication No. 2002-155118, Japanese Unexamined Patent Application Publication No. 2002-179731, Japanese Unexamined Patent Application Publication No. 2002-220419, Japanese Unexamined Patent Application Publication No. 2002-293840, Japanese Unexamined Patent Application Publication No. 2002-327013, Japanese Unexamined Patent Application Publication No. 2003-2925 and so on). However the resins are not necessarily sufficient for permeability (transparency)to a vacuum ultraviolet light. Further, a resin having properties such as a property of a part irradiated by light exposure changed to alkali-soluble by acid (acid-elimination function), resistance to dry etching (etching resistance) and adhesion to substrate (substrate adhesion) in addition to transparency to light used for exposure in balance rarely exists.

### DISCLOSURE OF INVENTION

An object of the present invention is to provide a novel polymerizable adamantane derivative which is useful for obtaining a polymeric compound having high permeability to a vacuum ultraviolet light with a wavelength of 300 nm or low, particularly F₂ excimer laser (157 nm) and others, and a producing process thereof.

Anther object of the present invention is to provide a novel polymerizable adamantane derivative which can give high transparency, excellent acid-eliminating function and etching resistance, to polymer, and can be easily co-polymerized with the other monomer to give various functions required as photoresists, and a production process thereof.

A further object of the present invention is to provide a polymeric compound which has high transparency to light with a wavelength of 300 nm or low, particularly vacuum ultraviolet light, and is excellent for acid-elimination function and etching resistance.

Another object of the present invention is to provide a polymeric compound which has high transparency to light used in exposure, and has acid-elimination function, etching resistance, substrate adhesion, and other various properties in balance.

The present inventors made intensive investigations to achieve the above objects and found a novel polymerizable adamantane derivative having a group with acid-elimination function having an adamantane skeleton in an alcohol moiety. Further findings are that this compound can be easily co-polymerized with the other monomers, which can give various functions required as photoresist, and the copolymerization provides a polymeric compound having high transparency to light with a wavelength of 300 nm or less, particularly vacuum ultraviolet light, and acid-elimination function, etching resistance, substrate adhesion, and other various properties in balance. The present invention was achieved based on these discoveries.

Specifically, the present invention provides a polymerizable adamantane derivative represented by the following formula (1): 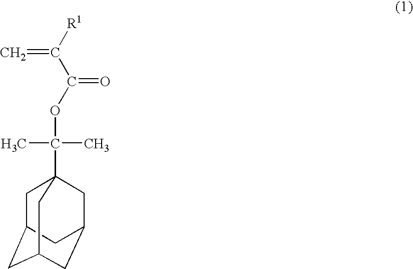
wherein R¹ is a fluorine atom or a fluoroalkyl group; and the adamantane ring in the formula may have a substituent.

Further, the present invention provides a process for producing a polymerizable adamantane derivative represented by the following formula (1): 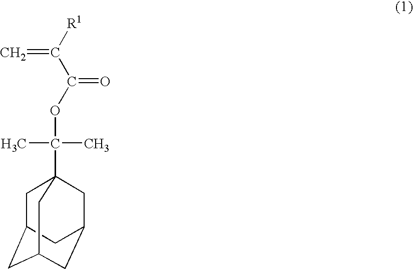
wherein R¹ a fluorine atom or a fluoroalkyl group; and the adamantane ring in the formula may have a substituent, the process comprising the step of allowing a compound represented by the following formula (2): 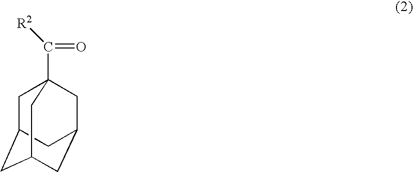
wherein R² is a halogen atom, an alkoxy group, an aryloxy group, an aralkyloxy group, an acyloxy group or a methyl group, and the adamantane ring in the formula may have a substituent, to react with a methylation reagent represented by the following formula (3):
CH₃-M (3)
wherein M is a metal atom or —MgX¹ group, wherein X¹ is a halogen atom, and allowing the resulting reaction product to react with an acyl halide represented by the following formula (4): 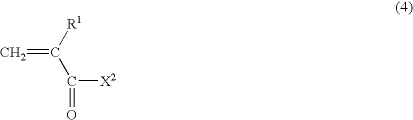
wherein R¹ is the same as defined above; and X² is a halogen atom.

In addition, the present invention provides process of producing a polymerizable adamantane derivative represented by the following formula (1): 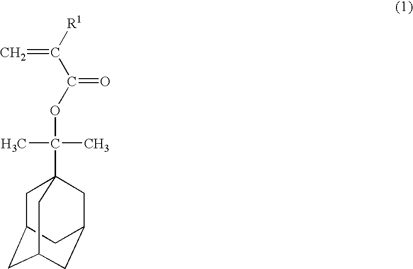
wherein R¹ is a fluorine atom or a fluoroalkyl group; and the adamantane ring in the formula may have a substituent, comprising the step of allowing an adamantane methanol derivative represented by the formula (5): 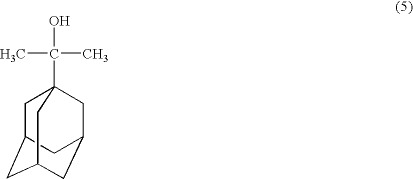
wherein an adamantane ring may have a substituent, to react with an unsaturated carboxylic acid represented by the formula (6): 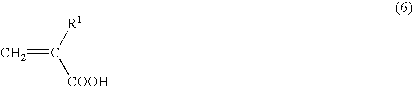
wherein R¹ is the same as defined above, or a reactive derivative thereof.

In addition, the present invention provides a polymeric compound comprising a repeated unit corresponding to the polymerizable adamantane derivative. The polymeric compound may further contain a repeated unit having substrate adhesion function and/or hydrophilicity function.

The present invention can provide a novel polymerizable and unsaturated monomer having a fluorine atom, which is useful for obtaining a polymeric compound having high permeability to light with a wavelength of 300 nm or low, particularly vacuum ultraviolet light such as F₂ excimer laser (157 nm), and a production process thereof. Further, the present invention provides a novel polymerizable and unsaturated monomer having a fluorine atom, which can give high transparency, excellent acid-elimination function, and etching resistance to a polymer, and can be easily co-polymerized with the other monomers to impart various functions required as photoresists, and a production process thereof.

A polymeric compound of the present invention has high transparency to light with a wavelength of 300 nm or less, particularly vacuum ultraviolet light, and is excellent for acid-elimination function. In case of the compound used for photoresist, various functions such as acid-elimination function, etching resistance, substrate adhesion, and hydrophilicity in balance. Therefore, micro patterns can be formed in high accuracy when using the said polymeric compound as photoresist resin.

### BEST MODE FOR CARRYING OUT THE INVENTION

### Polymerizable Adamantane Derivative

A polymerizable adamantane derivative of the present invention is shown by the above formula (1). This monomer is polymerized at an unsaturated portion of an unsaturated acyl group to provide a polymeric compound. This monomer can impart high transparency to light with a wavelength of 300 nm or less, particularly vacuum ultraviolet light to a polymer because of a fluorine atom a group having a fluorine atom combined with a carbon atom which is at the site of secondary position of an unsaturated acyl group (a position of a carbonyl group), and excellent etching resistance because of intramolecularly having an adamantane ring as an alicyclic hydrocarbon. Further, this monomer has a acid-elimination property-imparting function, because an acid-elimination reaction undergoes by the action of acid to yield a carboxylic acid corresponding to the unsaturated acyloxy group and an olefin compound to exhibit alkaline solubility since the monomer has a carbon atom having at least one hydrogen atom at the adjacent position of a carbon atom combined with an unsaturated acyloxy group. In addition, a monomer of the present invention is easy to co-polymerize with various monomers, for example, another acryl monomer, a vinylether monomer, and others, used for giving various functions required as photoresist (for example, substrate adhesion, hydrophilicity, transparency, etching resistance and so on). Therefore, a polymeric compound which is excellent to transparency against, for example, vacuum ultraviolet light and so on and has functions such as acid-elimination function, substrate adhesion, hydrophilicity and etching resistance in balance can be prepared easily.

In the formula (1), R¹ is a fluorine atom or a fluoro alkyl group. As the said fluoro alkyl group, there may be mentioned, for example, a linear chain or branched chain fluoroalkyl group having about one to about fifteen carbon atoms (preferably about one to about six carbon atoms, more preferably about one to about three carbon atoms) and so on. As typical examples of such a fluoroalkyl group, there may be mentioned a trifluoromethyl, a pentafluoroethyl, a 2,2,2-trifluoroethyl, a 2,2,2-trifluoro-1-(trifluoromethyl)ethyl, a heptafluoropropyl, a 2,2,3,3,3-heptafluoropropyl, a 2,2,3,3-tetrafluoropropyl, a nonafluorobutyl, a 2,2,3,3,4,4,4-heptafluorobutyl, a 2,2,3,3,4,4-hexafluorobutyl, a undecafluoropentyl, a 2,2,3,3,4,4,5,5,5-nonafluoropentyl, a 2,2,3,3,4,4,5,5-octafluoropentyl, a tridecafluorohexyl, a 2,2,3,3,4,4,5,5,6,6,6-undecafluorohexyl, a 2,2,3,3,4,4,5,5,6,6-decafluorohexyl, a pentadecafluoroheptyl, a 2,2,3,3,4,4,5,5,6,6,7,7,7-tridecafluoroheptyl, a 2,2,3,3,4,4,5,5,6,6,7,7-dodecafluoroheptyl, a heptadecafluorooctyl, a 2,2,3,3,4,4,5,5,6,6,7,7,8,8,8-pentadecafluorooctyl, a nonadecafluorononyl, a 2,2,3,3,4,4,5,5,6,6,7,7,8,8,9,9,9-heptadecafluorononyl, a heneicosafluorodecyl, a 2,2,3,3,4,4,5,5,6,6,7,7,8,8,9,9,10,10,10-nonadecafluorodecyl group and so on. As the R¹, a fluorine atom and fluoroalkyl group having one to three carbon atoms are preferable, and particularly a trifluoromethyl group is preferable.

An adamantane ring in the formula (1) may have a substituent group. As the said substituent group there may be mentioned, for example, a halogen atom, an alkyl group, a haloalkyl group, an aryl group, a hydroxyl group which may be protected by a protective group, a hydroxy(halo)alkyl group which may be protected by a protective group, an amino group which may be protected by a protective group, a carboxyl group which may be protected by a protective group, a sulfo group which may be protected by a protective group, an oxo group, a nitro group, a cyano group, an acyl group which may be protected by a protective group and so on.

As the said halogen atom, there may be mentioned, for example, a fluorine, a chlorine, a bromine atom and others. As the alkyl group, there may be mentioned, for example, methyl, ethyl, propyl, isopropyl, butyl, isobutyl, s-butyl, t-butyl, hexyl, octyl, decyl, and other C₁ to C₁₀ alkyl groups, preferably C₁ to C₅ alkyl groups. As the haloalkyl group, there may be mentioned, for example, a chloroalkyl group such as a chloromethyl group; trifluoromethyl, 2,2,2-trifluoroethyl, pentafluoroethyl, and other fluoroalkyl groups (for example, C₁ to C₁₀ fluoroalkyl groups, preferably C₁ to C₅ fluoroalkyl groups) and so on. As the aryl group, there may be mentioned, for example, phenyl, naphthyl group and others. An aromatic ring of the aryl group may have a substituent. Such substituent includes, for example, a halogen atom such as a fluorine atom, C₁ to C₄ alkyl groups such as a methyl group, C₁ to C₅ haloalkyl groups such as a trifluoromethyl group, a hydroxyl group, C₁ to C₄ alkoxy groups such as a methoxy group, an amino group, a dialkylamino group, a carboxyl group, alkoxycarbonyl groups such as a methoxycarbonyl group, a nitro group, a cyano group, acyl groups such as an acetyl group. As the hydroxy(halo)alkyl group, there may be mentioned, for example, hydroxymethyl, hydroxyethyl, hydroxypropyl, 1-hydroxy-1-methylethyl group, 2,2,2-trifluoro-1-trifluoromethyl-1-hydroxyethyl group and others [preferably a hydroxy-C₁ to C₄ alkyl group, a hydroxy-C₁ to C₄ haloalkyl group and others].

As a protective group of hydroxyl group in the said hydroxyl group and hydroxy(halo)alkyl group, protective groups commonly used in the field of organic synthesis, for example, an alkyl group (for example, methyl, t-butyl, and other C₁ to C₄ alkyl group), an alkenyl group (for example, an aryl group), a cycloalkyl group (for example, cyclohexyl group), an aryl group (for example, 2,4-dinitrophenyl group), an aralkyl group (for example, benzyl group); a substituted methyl group (for example, methoxymethyl, methylthiomethyl, benzyloxymethyl, t-butoxymethyl, 2-methoxyethoxymethyl group), a substituted ethyl group (for example, 1-ethoxyethyl group), tetrahydropyranyl group, tetrahydrofuranyl group, 1-hydroxyalkyl group (for example, 1-hydroxyethyl group) and other groups which can form acetal or hemi-acetal group with a hydroxyl group; an acyl group (for example, formyl, acetyl, propionyl, butyryl, isobutyryl, pivaloyl, and other C₁ to C₆ aliphatic acyl groups; an acetoacetyl group; benzoyl, and other aromatic acyl group), an alkoxycarbonyl group (for example, a methoxycarbonyl group, and other C₁ to C₄ alkoxy-carbonyl groups), an aralkyloxycarbonyl group, a substituted or unsubstituted carbamoyl group, a substituted silyl group (for example, a trimethylsilyl group and others), and a bivalent hydrocarbon group which may have a substituent (for example, methylene, ethylidene, isopropylidene, cyclopentylidene, cyclohexylidene, benzylidene and other groups) when two or more hydroxyl groups (including a hydroxymethyl group) exist in the molecule can be exemplified.

As the said protective group of an amino group, there may be mentioned, for example, an alkyl group, an aralkyl group, an acyl group, an alkoxycarbonyl group exemplified as the said protective group of a hydroxyl group and others. Further, as the protective group of carboxyl group and sulfo group, there may be mentioned, for example, an alkoxy group (for example, methoxy, ethoxy, butoxy, and other C₁ to C₆ alkoxy groups), a cycloalkyloxy group, an aryloxy group, an aralkyloxy group, a trialkylsilyloxy group, an amino group which may have a substituent, a hydrazino group, an alkoxycarbonylhydrazino group, an aralkylcarbonylhydrazino and others.

As the said acyl group, there may be mentioned, for example, a C₁ to C6 aliphatic acyl group such as formyl, acetyl, propionyl, butyryl, isobutyryl and pivaloyl group; an acetoacetyl group; an aromatic acyl group such as a benzoyl group; and others. As the protective group of an acyl group, protective groups commonly used in the organic synthesis field can be used. As a form of the protected acyl group, there may be mentioned, for example, an acetal (including a hemi-acetal) and others.

As the typical examples of polymerizable adamantane derivative represented by the formula (1), there may be mentioned, for example, 1-[1-(2-trifluoromethyl-2-propenoyloxy)-1-methylethyl]adamantane, 1-[1-(2-trifluoromethyl-2-propenoyloxy)-1-methylethyl]-3-hydroxyadamantane, 1-[1-(2-trifluoromethyl-2-propenoyloxy)-1-methylethyl]-3,5-dihydroxyadamantane, 1-[1-(2-trifluoromethyl-2-propenoyloxy)-1-methylethyl]-3,5-dimethyladamantane, 1-carboxy-3-[1-(2-trifluoromethyl-2-propenoyloxy)-1-methylethyl]adamantane, and other compounds where R¹ in the formula (1) is a trifluoromethyl group; and a compound corresponding to the said compound where R¹ is a fluorine atom and so on.

### Production of Polymerizable Adamantane Derivative

A polymerizable adamantane derivative of the present invention can be produced by reacting a compound represented by the formula (2) with a methylation reagent represented by the formula (3), and reacting the obtained reaction product with an acyl halide represented by the formula (4).

In the formula (2), R² is a halogen atom, an alkoxy group, an aryloxy group, an aralkyloxy group, an acyloxy group or a methyl group. As the halogen atom, there may be mentioned, for example, a chlorine atom, a bromine atom, a iodine atom and so on. As the alkoxy group, there may be mentioned, for example, a methoxy, an ethoxy, a propoxy, an isopropoxy, a butoxy, an isobutyloxy, a t-butyloxy, a pentyloxy, a hexyloxy, and other C₁ to C₁₀ alkoxy groups (preferably C₁ to C₄ alkoxy groups). The aryloxy includes, for example, a phenyloxy, a naphtyloxy group and so on. As the aralkyloxy, there may be mentioned, for example, an C₇ to C₁₅ aralkyloxy group such as a benzyloxy and a 2-phenylethyloxy group, and so on. As the acyloxy group, there may be mentioned, for example, an aliphatic acyloxy group such as an acetyloxy and a propionyloxy group, an alicyclic acyloxy group such as a cyclohexyl carbonyloxy group and an aromatic acyloxy group such as a benzoyloxy group, and other C₁ to C₁₁ acyloxy groups (preferably C₂ to C₆ acyloxy groups).

An adamantane ring in the formula (2) may have a substituent group and as the said substituent group, there may be mentioned the same as the substituent group which the adamantane ring of the above formula (1) may have.

As a metal atom in M of the formula (3), there may be mentioned lithium and so on. The said metal atom may have a ligand. In a compound represented by the formula (3), a compound in which M is a —MgX¹ group is commonly called as Grignard reagent. The Grignard reagent can be prepared by a conventional method. As a halogen atom in X¹, there may be mentioned a chlorine atom, a bromine atom, an iodine atom and so on.

In the formula (4), R¹ is the same as above and X² is a halogen atom. As the halogen atom in X², there may be mentioned a chlorine atom, a bromine atom, an iodine atom and others.

A reaction (a prior reaction) of a compound represented by the formula (2) and a methylation reagent represented by the formula (3) is carried out in the presence of, or in the absence of, a solvent. As the solvent, there may be mentioned, for example, an ether such as diethylether and tetrahydrofuran, a hydrocarbon such as hexane and toluene, an amide such as N,N-dimethylfolmamide, dimethylsulfoxide and others. When a compound of formula (2) where R² is a methyl group is used as the compound of the formula (2), the amount of the compound represented by the formula (3) is about one to two moles per 1 mole of the compound represented by the formula (2). Further, when a compound of formula (2) where R² is a halogen atom, an alkoxy group, an aryloxy group, an aralkyloxy group, or an acyloxy group is used as the compound of the formula (2), the amount of the compound represented by the formula (3) is about two to three moles per 1 mole of a compound represented by the formula (2). A reaction temperature, depends on a sort of raw material, and can be usually selected in a scope of about 0 to 150° C.

A reaction mixture obtained by the reaction of the compound of the formula (2) and the methylation reagent of the formula (3) can be subjected to a reaction (a posterior reaction) with a compound represented by the formula (4) as intact, and may be subjected to the posterior reaction after performing a treatment such as dilution, concentration and solvent-exchange. In the posterior reaction, the amount of the compound represented by the formula (4) is about 1 to 1.5 moles per 1 mole of the compound represented by the formula (2) used in the prior reaction. A reaction temperature in the posterior reaction is, for example, about 0 to 150° C. A reaction product can be separated and purified by a means such as extraction, rinse with water, concentration, distillation, crystallization, re-crystallization and column chromatography.

In addition, among the compound represented by formula (2) used as a raw material, a compound where R² is a halogen atom (an adamantane carboxylic acid halide) can be produced by allowing an adamantane carboxylic acid to react with a halogenation reagent such as thionyl chloride. Further, in a compound represented by the formula (2), a compound where R² is an alkoxy group, an aryloxy group or an aralkyl group (an adamantane carboxylic acid ester) can be prepared by reacting an adamantane carboxylic acid with a corresponding alcohol or phenol in the presence of an acid catalyst, or by reacting a compound represented by the formula (2) where R² is a halogen atom with a corresponding alcohol or phenol in the presence of base. Among the compounds represented by the formula (2), a compound where R² is an acyloxy group (an adamantane carboxylic acid anhydride) can be obtained by a dehydration reaction of an adamantane carboxylic acid. In addition, among the compounds represented by the formula (2), a compound where R² is a methyl group (an adamantyl ketone) can be produced by, for example, a method described in a PCT International Publication No. WO 99/41219 pamphlet. Each of the reactions can adopt a reaction condition which is usually used.

A polymerizable adamantane derivative of the present invention, can be further obtained by reacting an adamantane methanol derivative represented by the formula (5) with an unsaturated carboxylic acid represented by the formula (6) or a reactive derivative thereof. As the reactive derivative of the unsaturated carboxylic acid represented by the formula (6), there may be mentioned an acid halide (an acid chloride, an acid bromide and others), an acid anhydride, an ester (a methyl ester, an ethyl ester and others) and so on.

In this reaction, in case of an unsaturated carboxylic acid represented by the formula (6) used as one raw material, an acid such as sulfuric acid, hydrochloric acid, p-toluene sulfonic acid and a strong acidic ion-exchanging resin is used as a catalyst. It is preferable that a reaction is preformed in an inactive solvent such as toluene. In addition, a reaction rate can be accelerated by performing a reaction while distilling out by-produced water. The amount of the unsaturated carboxylic acid represented by the formula (6) is usually about 0.9 to 1.3 moles per one mole of an adamantane methanol derivative represented by the formula (5). A reaction temperature depends on a sort of raw material, and is commonly about 20 to 150° C.

In the above reaction, in case of an acid halide or an acid anhydride of the unsaturated carboxylic acid represented by the formula (6) used as one raw material for a reaction, the reaction is usually performed in the presence of base. As the base, for example, an organic base such as triethylamine and pyridine; and an inorganic base such as sodium hydroxide, sodium carbonate and sodium hydrogencarbonate can be used. The amount of base is usually about 1 to 1.5 equivalent relative to an acid halide or an acid anhydride of the unsaturated carboxylic acid represented by the formula (6), however the base may be used in large excess. It is preferable that a reaction is preformed in an inactive solvent for the reaction such as toluene, methylene dichloride and tetrahydrofuran. The amount of the acid halide or the acid anhydride of the unsaturated carboxylic acid represented by the formula (6) is usually about 0.9 to 1.3 moles per one mole of an adamantane methanol derivative represented by the formula (5). A reaction temperature depends on a sort of raw material used in the reaction, and is commonly about −10 to 100° C.

In the above reaction, in case of an ester of an unsaturated carboxylic acid represented by the formula (6) used as one raw material for the reaction, it is preferable that an ester-exchanging catalyst is used as a catalyst. As the ester-exchanging catalyst, aluminum compound, a titan compound, and other metal compounds commonly used in a field of organic synthesis can be used. It is preferable that a reaction is preformed in an solvent which is inactive to the reaction, such as toluene. It is also allowed to perform the reaction while distilling out an alcohol by-produced in the reaction. An used amount of an ester of an unsaturated carboxylic acid represented by the formula (6) is usually about 0.9 to 1.3 moles based on one mole of an adamantane methanol derivative represented by the formula (5). A reaction temperature depends on a sort of used raw material, and can be properly selected in a scope of about 20 to 150° C. commonly. In each of the method, a reaction product can be separated and purified by a separating means such as filtration, concentration, distillation, extraction, crystallization, re-crystallization and column chromatography.

In addition, an adamantane methanol derivative represented by the formula (5) used as a raw material can be produced by following to, for example, a method described in a PCT International Publication No. WO99/54271 pamphlet.

### Polymeric Compound

A polymeric compound of the present invention contains a repeated unit (a monomer unit) corresponding to a polymerizable adamantane derivative represented by the above formula (1) of the present invention. The said repeated unit may be one sort or two or more sorts. Such a polymeric compound can be obtained by subjecting the said polymerizable adamantane derivative to polymerization.

In order to sufficiently have various functions required as a resist in balance, a polymeric compound of the present invention may have the other repeated unit in addition to a repeated unit corresponding to the above polymerizable adamantane derivative of the present invention. Such the other repeated unit can be formed by co-polymerizing a polymerizable unsaturated monomer (for example, a (meth)acrylic acid eater, a vinylether and others) corresponding to the repeated unit with a polymerizable adamantane derivative. As the said other repeated unit, there may be mentioned, for example, a repeated unit having substrate adhesion and/or hydrophilic function, a repeated unit improving acid-elimination function, a repeated unit improving etching resistance function, a repeated unit improving transparency and so on. The above hydrophilic function includes a function improving a solubility to a resist solvent and an alkali developer. Further, compounds used for performing co-polymerization smoothly, or unifying a copolymer composition can be used as a co-monomer when preparing a polymeric compound of the present invention.

The repeated unit having substrate adhesion and/or hydrophilic function can be introduced into a polymer by using a polymerizable unsaturated monomer having a polar group as a co-monomer. As the said polar group, there may be mentioned, for example, a hydroxyl group which may have a protective group, a carboxyl group which may have a protective group, an amino group which may have a protective group, a sulfo group which may have a protective group, a group having a lactone ring and so on. As the said protective group, one commonly used in the organic synthesis field can be used (for example the protective groups described above). As a polymerizable unsaturated monomer having a polar group, a conventional compound in the resist field can be applied. As a typical example of a polymerizable unsaturated monomer having a polar group, there may be mentioned, for example, a polymerizable monomer having a lactone ring in the molecule [a (meth)acrylic acid ester, a vinyl ether and others] such as γ,γ-dimethyl-α-vinyloxy-γ-butyrolactone and 1-vinyloxy-4-oxatricyclo[4.3.1.1^{3,8}]undecan-5-one, a polymerizable monomer having an alicyclic hydrocarbon bonded by a hydroxyl group such as 2-trifluoroacrylic acid 4-hydroxycyclohexyl [(meth)acrylic acid ester, a vinyl ether and others and others] and so on.

A repeated unit improving acid-eliminating function can be introduced to a polymer by using, for example, (1) a (meth)acrylic acid ester derivative in which a hydrocarbon having a tertiary carbon, a 2-tetrahydrofuranyl group, a 2-tetrahydropyranyl group or others are combined at the adjacent position of oxygen atom constituting the ester, (2) a (meth)acrylic acid ester derivative which have a hydrocarbon group (an alicyclic hydrocarbon group, an aliphatic hydrocarbon group, a group bonded by these groups, and others) at the adjacent position of oxygen atom constituting the ester, and the hydrocarbon group is combined with —COOR^{a} group, wherein R^{a} is a tertiary hydrocarbon group, a 2-tetrahydrofuranyl group, a 2-tetrahydropyranyl group or others, directly or via linkage group as a co-monomer. In addition, a carbon atom at the adjacent position of a tertiary carbon of tertiary hydrocarbon group in the said R needs to be combined with at least a hydrogen atom. As such a (meth)acrylic acid eater derivative, conventional compounds in the resist field can be used.

A repeated unit improving etching resistance function can be introduced to a polymer by using, for example, a polymerizable monomer having an alicyclic structure in the molecule as a co-monomer. Further, a repeated unit improving transparency for vacuum ultraviolet light and others can be introduced to a polymer, for example, by using a polymerizable monomer having a fluorine atom in the molecule as a co-monomer.

In a polymeric compound of the present invention, a ratio of a repeated unit corresponding to an polymerizable adamantane derivative represented by the formula (1) is not particularly limited and is usually 1 to 80% by mole, preferably 5 to 75% by mole, more preferably 10 to 60% by mole, particularly about 20 to 70% by mole based on the total monomer units constituting the polymer. An the total ratio of an repeated unit having acid-elimination function is, for example, 5 to 80% by mole, preferably about 10 to 60% by mole based on all monomer units constituting the polymer. A ratio of an repeated unit having substrate adhesion and/or hydrophilicity function is, for example, 20 to 95% by mole, preferably about 40 to 90% by mole based on the total monomer units constituting the polymer.

When subjecting a (co-)polymerizable monomer of the present invention to co-polymerization to obtain a polymeric compound, solution polymerization, bulk polymerization, suspension polymerization, bulk-suspension polymerization and emulsion polymerization and other polymerization commonly used in the production of acryl polymer and others can be carried out. Particularly, solution polymerization is preferable. In the solution polymerization, dropwise polymerization may be applied in order to obtain homogeneous polymer.

As a polymerization solvent, a conventional solvent can be used and there may be mentioned, for example, an ether (diethyl ether, glycol ethers such as propylene glycol monomethyl ether, and other linear-chain ethers, tetrahydrofuran, dioxane, and other cyclic ethers), an ester (methyl acetate, ethyl acetate, butyl acetate, ethyl lactate, a glycol ether esters such as propylene glycol monomethyl ether acetate and so on), a ketone (acetone, methyl ethyl ketone, methyl isobutyl ketone, cyclohexanone and so on), an amide (N,N-dimethylacetoamide, N,N-dimethylformamide and so on), a sulfoxide (dimethylsulfoxide and so on), an alcohol (methanol, ethanol, propanol and so on), a hydrocarbon (an aromatic hydrocarbon such as benzene, toluene and xylene, an aliphatic hydrocarbon such as hexane, an alicyclic hydrocarbon such as cyclohexane, and others), a mixed solvent thereof and so on. Further, as a polymerization initiator, a conventional polymerization initiator can be applied. A polymerization temperature can be appropriately selected, for example, in a scope of from about 30 to about 150° C.

A polymer obtained by polymerization can be purified by precipitation or reprecipitation. A solvent for precipitation or reprecipitation may be either an organic solvent or water and further a mixing solvent may be well. As an organic solvent used for precipitation or reprecipitation solvent, there may be mentioned, for example, a hydrocarbon (pentane, hexane, heptane, octane, and other aliphatic hydrocarbons; cyclohexane, methylcyclohexane, and other alicyclic hydrocarbons; benzene, toluene, xylene, and other aromatic hydrocarbons), a halogenated hydrocarbon (a halogenated aliphatic hydrocarbon such as methylene chloride, chloroform and carbon tetrachloride; a halogenated aromatic hydrocarbon such as chlorobenzene and dichlorobenzene, and so on), a nitro compound (such as nitromethane and nitroethane), a nitrile (such as acetonitrile and benzonitrile), an ether (a linear chain ether such as diethyl ether, diisopropyl ether and dimethoxyethane; a cyclic ether such as tetrahydrofuran and dioxane), a ketone (such as acetone, methyl ethyl ketone and diisobutyl ketone), an ester (such as ethyl acetate and butyl acetate), a carbonate (such as dimethyl carbonate, diethyl carbonate, ethylene carbonate and propylene carbonate),an alcohol (such as methanol, ethanol, propanol, isopropylalcohol and butanol), a carboxylic acid (such as acetic acid), a mixed solvent containing these solvent and so on.

A weight average molecular weight (Mw) of the polymeric compound is, for example, from about 1000 to about 500000, preferably from about 3000 to about 50000, and a molecular weight distribution (Mw/Mn) is, for example, from about 1.5 to about 2.5. Incidentally, the said Mn is a number average molecular weight and both Mn and Mw are in terms of polystyrene.

### Resin Compositions for Photoresist and Semiconductor Manufacture

A photoresist resin composition can be prepared by mixing the said polymeric compound of the present invention and a photo-acid generator. The photoresist resin composition may contain a polymer other than the above polymeric compounds as far as adversely affected to the resist function.

As a photo-acid generator, a compound conventional used or commonly known as to effectively providing acid by the action of exposure, for example, a diazonium salt, an iodonium salt (for example, diphenyl iodo hexafluorophosphate and so on), a sulfonium salt (for example, triphenyl sulfonium hexafluoroantimonate, triphenyl sulfonium hexafluorophosphate, triphenyl sulfonium methane sulfonate and so on), a sulfonic acid ester [for example, 1-phenyl-1-(4-methylphenyl)sulfonyloxy-1-benzoylmethane, 1,2,3-trisulfonyloxymethylbenzene, 1,3-dinitro-2-(4-phenylsulfonyloxymethyl)benzene, 1-phenyl-1-(4-methylphenylsulfonyloxymethyl)-1-hydroxy-1-benzoylmethane and so on], an oxathiazol derivative, s-triazine derivative, a disulfone derivative (such as diphenyldisulfone), an imide compound, an oxime sulfonate, diazonaphtoquinone, benzoin tosylate and others can be applied. These photo-acid generators can be used by alone or in combination of 2 or more sorts.

The amount of photo-acid generator can be appropriately selected depending on strength of the acid generated by photo-exposure, a ratio of each repeated unit of the polymer and others, and for example, from about 0.1 to about 30 part by weight, preferably from about 1 to about 25 part by weight, and preferably from about 2 to about 20 part by weight, relative to 100 part by weight of the polymeric compound.

A photoresist resin composition may contain, if necessary, an alkali soluble component such as an alkali soluble resin (for example, a novolac resin, a phenol resin, an imide resin, carboxyl group-containing resin and so on), a coloring agent (for example, dyes), an organic solvent (for example, such as hydrocarbons, halogenated hydrocarbons, alcohols, esters, amides, ketones, ethers, cellosolves, carbitols, glycol ether esters, and mixed solvent of them), a basic compound (such as a hindered amine), a detergent, a anti-soluble agent, a sensitizer, a stabilizer and others.

A photoresist resin composition obtained by these procedures is coated on a base or substrate, and dried, the applied film (resist film) is exposed to light (or, further baked after exposure) to form a latent pattern, and is subsequently developed to form a fine pattern with a high degree of precision.

As a base or substrate, there may be mentioned silicon wafer, metal, plastics, glass, ceramic and so on. The photoresist resin composition can be applied using a conventional application means such as a spin coater, a dip coater, a roller coater. The applied film has a thickness of, for example, from about 0.01 to about 20 μm, and preferably from about 0.05 to about 1 μm.

Light rays with different wavelengths such as ultraviolet rays and X-rays can be used in exposure. For example, g-light, i-light, excimer laser (for example, XeCl, KrF, KrCl, ArF, ArCl, F₂, Kr₂, KrAr, Ar₂ and so on) are usually used for semiconductor resist. An exposure energy is, for example, from about 0.1 to about 1000 mJ/cm².

Light irradiation allows the photosensitive acid generator to generate an acid, and the acid allows, for example, the eliminating portion of acid-eliminating group of the said polymeric compound to leave promptly and thereby yields a carboxyl group that contributes to solubilization. Therefore, development with water or an alkaline developing solution can yield a predetermined pattern with a high degree of precision.

### EXAMPLES

The present invention will be illustrated in more detail with reference to several examples below, which is not intended to limit the scope of the invention. Figures of the right-under brackets in the structural formulae of polymers denote % by mole of the prepared monomer corresponding to the repeated unit (monomer unit). A weight average molecular weight (Mw) and a molecular weight distribution (Mw/Mn) are measured by a GPC measurement using a refractometer (RI) and tetrahydrofuran (THF) as a detector and an eluent, respectively in terms of standard polystyrene. Three columns KF-806L (commercial name) manufactured by SHOUWA DENKO Inc. are connected in series to use for GPC and the reaction is performed under the condition comprising the column temperature of 40° C., RI temperature of 40° C., and eluent flow rate of 0.8 ml/min.

### Production Example 1

To a three-necked flask equipped with a thermometer, 11.6 g (0.1 mol) of 1,4-cyclohexanediol, 12.1 g (0.12 mol) of triethylamine and 200 ml of tetrahydrofuran were added, and was stirred under nitrogen gas stream while cooling on ice. To the mixture 19.0 g (0.12 mol) of 2-trifluoromethyl acrylic acid chloride was added, and was stirred for 2 hours at room temperature. After the reaction the mixture was concentrated under reduced pressure, 300 ml of pure water was added to the concentrated residue and extracted twice with 300 ml of ethylacetate. The organic layers were united, washed with 300 ml of 5 weight % sodium bicarbonate aqueous solution and 300 ml of 10 weight % salt aqueous solution, respectively, dried by magnesium sulfate, and concentrated under reduced pressure. By purifying the concentrated residue by silica gel column chromatography 13.8 g (0.058 mol) of 2-trifluoromethylacrylic acid 4-hydroxycyclohexyl [=1-(2-trifluoromethyl-2-propenoyloxy)-4-hydroxycyclohexane] represented by the following formula (7) was obtained.

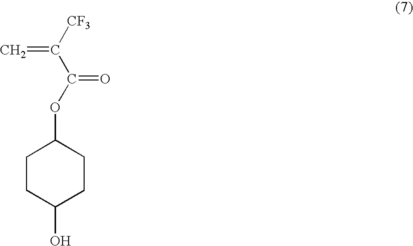

Further, γ,γ-dimethyl-α-vinyloxy-γ-butyrolactone [the following formula (8)] used as a monomer in the following example was a monomer synthesized using α-hydroxy-γ,γ-dimethyl-γ-butyrolactone and vinyl acetate according to a method described in Japanese Unexamined Patent Application Publication No. 2003-73321, and purified by distillation under reduced pressure.

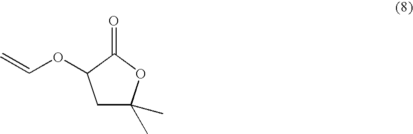

In addition, the used 1-vinyloxy-4-oxatricyclo[4.3.1.1^{3,8}]undecan-5-one [the following formula (9)] was synthesized from 1-hydroxy-4-oxatricyclo[4.3.1.1^{3,8}]undecan-5-one and vinyl acetate according to a method described in Japanese Unexamined Patent Application Publication No. 2003-73321, and purified by an alumina column chromatography.

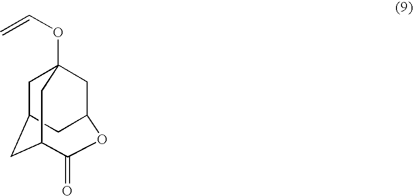

### Example 1

A three-necked flask equipped with a thermometer, a Dimroth condenser and a inlet of nitrogen was fulfilled by nitrogen and 73 ml of 3M methyl magnesium chloride-tetrahydrofuran solution was placed in it. While the solution was stirred at room temperature, a solution of 20 g of 1-adamantane carbonyl chloride dissolved in 25 ml of toluene was dropped over 30 minutes. After dropping, the reaction mixture was stirred for 2 hours while heating and refluxing. After cooling the reaction mixture until room temperature, 20.6 g of 2-trifluoromethyl acryl acid chloride was dropped in for one hour. After dropping, the reaction mixture was stirred for 2 hours while heating and refluxing. After standing to cool the reaction mixture until room temperature, 100 ml of water and 100 ml of ethyl acetate were added, the organic layer was separated, dried by magnesium sulfate and then concentrated under reduced pressure. By subjecting the concentrated residue to silicagel chromatography, 18.3 g of 1-[1-(2-trifluoromethyl-2-propenoyloxy)-1-methylethyl]adamantane represented by the formula (10) was obtained.

### Specter Data of -[1-(2-trifluoromethyl-2-propenoyloxy)-1-methylethyl]adamantane

¹H-NMR (DMSO-d₆) δ: 1.46 (s, 6H), 1.56-1.67 (m, 12H), 1.97 (s, 3H), 6.58 (s, 1H), 6.70 (s, 1H)

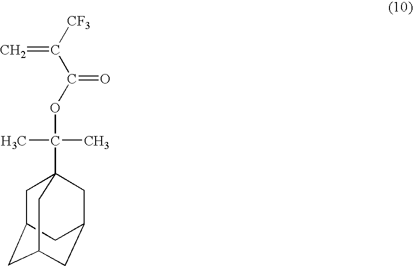

### Example 2

To a three-necked flask equipped with a thermometer, 19.4 g (0.1 mol) of 1-(1-adamantyl)-1-methylethanol, 30.3 g (0.3 mol) of triethylamine and 200 ml of tetrahydrofuran were placed and stirred while cooling under nitrogen gases. In this mixed solution 22.9 g (0.14 mol) of 2-trifluoromethyl acrylic acid chloride was added and stirred for 2 hours at room temperature. After the reaction, 500 ml of pure water was added, tetrahydrofuran and triethylamine were distilled off under reduced pressure, and 1 L of ethyl acetate was added to perform extraction. The organic layer was washed with 500 ml of 5% by weight sodium hydrogencarbonate aqueous solution and 500 ml of 10% by weight salt aqueous solution separately, dried by magnesium sulfate and then concentrated under reduced pressure. By subjecting the concentrated residue to silicagel chromatography, 28 g (0.089 mol) of 1-[1-(2-trifluoromethyl-2-propenoyloxy)-1-methylethyl]adamantane represented by the formula (10) was obtained. The raw material 1-(1-adamantyl)-1-methylethanol was synthesized by reacting 1-adamantane carboxylic acid chloride with methyl magnesium bromide according to a method described in the reference [J. Med. Chem., 14, 535-543(1971)].

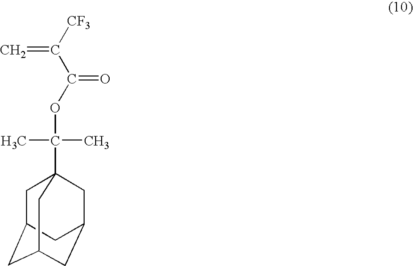

### Example 3

Synthesis of the polymeric compound of the following formula:

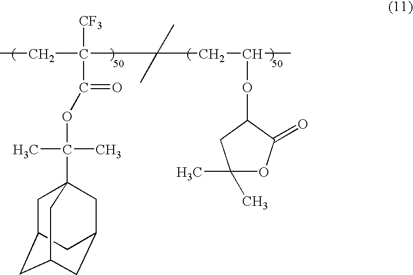

In a 100 ml round-bottom flask equipped with a reflux condenser, a stirrer and three-way cock, 6.69 g (21.2 mmol) of 1-[1-(2-trifluoromethyl-2-propenoyloxy)-1-methylethyl]adamantane, 3.31 g (21.2 mmol) of γ,γ-dimethyl-α-vinyloxy-γ-butyrolactone and 0.10 g of initiator [manufactured by WAKO JUNYAKU INDUSTRY Inc., trade name “V-65”] were placed and dissolved in 5.0 g of propylene glycol monomethyl ether acetate (PGMEA). Then, after the inside of flask was replaced by dry nitrogen, the temperature of reaction system was kept at 60° C. and stirred for 3 hours under nitrogen atmosphere. The reaction mixture was diluted with 30.0 g of tetrahydrofuran, then dropped into 500 g of a mixed liquid comprising 450 g of hexane and 50 g of ethyl acetate, and the generated precipitates were filtrated and, as the result, the purification was completed. The recovered precipitates were dried under reduced pressure, dissolved in 35 g of tetrahydrofuran, dropped into 500 g of a mixed liquid comprising 450 g of hexane and 50 g of ethyl acetate, and the generated precipitates was filtrated and, as the result, the purification was repeated. After drying under reduced pressure, the obtained polymer was 7.5 g. According to GPC analysis of this polymer, the weight-average molecular weight in terms of polystyrene was 7800 and the molecular-weight distribution was 2.10. Further, as result of the ¹³C-NMR (in CDCl₃) analysis, the composition ratio of polymer was 54:46 (molar ratio) (in order of the left side of the formula).

### Example 4

Synthesis of the polymeric compound of the following formula:

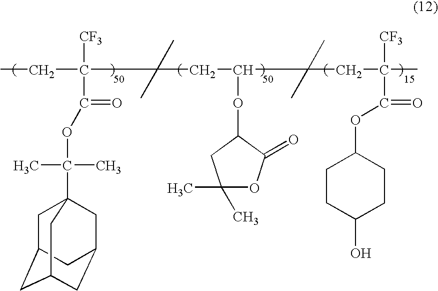

The polymeric compound was synthesized in the same manner as in Example 3 except for using 4.93 g (15.6 mmol) of 1-[1-(2-trifluoromethyl-2-propenoyloxy)-1-methylethyl]adamantane, 3.48 g (22.3 mmol) of γ,γ-dimethyl-α-vinyloxy-γ-butyrolactone and 1.59 g (6.7 mmol) of 1-(2-trifluoromethyl-2-propenoyloxy)-4-hydroxycyclohexane as raw materials. After drying under reduced pressure, the obtained polymer was 8.2 g. According to GPC analysis of this polymer, the weight-average molecular weight in terms of polystyrene was 8200 and the molecular-weight distribution was 2.12. Further, as result of the ¹³C-NMR (in CDCl₃) analysis, the composition ratio of polymer was 38:45:17 (molar ratio) (in order of the left side of the formula).

### Example 5

Synthesis of the polymeric compound of the following formula:

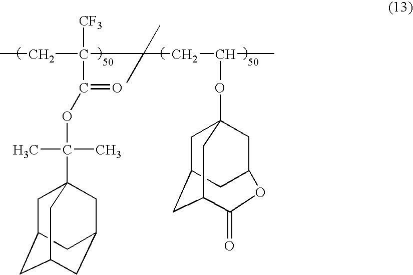

The polymeric compound was synthesized in the same manner as in Example 3 except for using 6.03 g (19.1 mmol) of 1-[1-(2-trifluoromethyl-2-propenoyloxy)-1-methylethyl]adamantane and 3.97 g (19.1 mmol) of 1-vinyloxy-4-oxatricyclo[4.3.1.1^{3,8}]undecan-5-one as raw materials. After drying under reduced pressure, the obtained polymer was 7.1 g. According to GPC analysis of this polymer, the weight-average molecular weight in terms of polystyrene was 7600 and the molecular-weight distribution was 1.96. Further, as result of the ¹³C-NMR (in CDCl₃) analysis, the composition ratio of polymer was 55:45 (molar ratio) (in order of the left side of the formula).

### Example 6

Synthesis of the polymeric compound of the following formula:

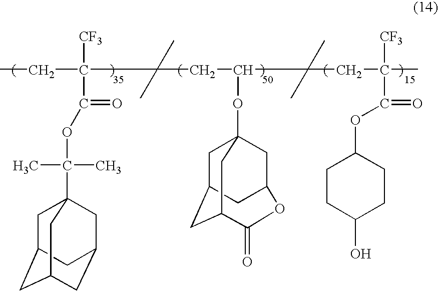

The polymeric compound was synthesized in the same manner as in Example 3 except for using 4.42 g (14.0 mmol) of 1-[1-(2-trifluoromethyl-2-propenoyloxy)-1-methylethyl]adamantane, 4.16 g (20.0 mmol) of 1-vinyloxy-4-oxatricyclo[4.3.1.1^{3,8}]undecan-5-one and 1.43 g (6.0 mmol) of 1-(2-trifluoromethyl-2-propenoyloxy)-4-hydroxycyclohexane as raw materials. After drying under reduced pressure, the obtained polymer was 7.3 g. According to GPC analysis of this polymer, the weight-average molecular weight in terms of polystyrene was 7700 and the molecular-weight distribution was 2.05. Further, as result of the ¹³C-NMR (in CDCl₃) analysis, the composition ratio of polymer was 36:46:18 (molar ratio) (in order of the left side of the formula).

### Valuation Test

### Transparency of Polymer

1 g of each of the polymers obtained in the above Examples 3 to 6 was dissolved in 10 g of propylene glycol monomethyl ether acetate (PGMEA), and was filtered through a filter of 0.2 μm to prepare a polymer solution. The polymer solution was applied onto a MgF₂ substrate by spin coating, was baked on a hot plate at a temperature of 100° C. for 120 seconds to form a polymer film 100 nm thick. Light transparency at 157 nm wavelength of the film was measured by using a vacuum-ultraviolet photometer [manufactured by NIHON BUNKO Inc., VUV-200S] and was found to be 50% or more in any case.

### Preparation of Resist and Formation of Pattern

100 parts by weight of each of the polymers obtained in the above Example 3 to 6 and 10 parts by weight of triphenylsulfonium hexafluoroantimonate were mixed with a solvent propyleneglycol monomethyl ether acetate (PGMEA) to prepare a photoresist resin composition of 17% by weight polymer-concentration. This composition was applied onto a silicon wafer by spin coating method to form a photosensitive layer of 1.0-μm thickness. The photosensitive layer was subjected to prebaking on a hot plate at a temperature of 100° C. for 150 seconds and was exposed to light through a mask using KrF excimer laser with a wavelength of 247 nm at an irradiance of 30 mJ/cm². The exposed layer was then subjected to post-exposure baking at a temperature of 100° C. for 60 seconds; was subjected to development in a 0.3 M aqueous tetramethylammonium hydroxide solution for 60 seconds; and was rinsed with pure water to yield a pattern with a 0.20-μm line and space in any case.

1. A polymerizable adamantane derivative represented by the following formula (1): 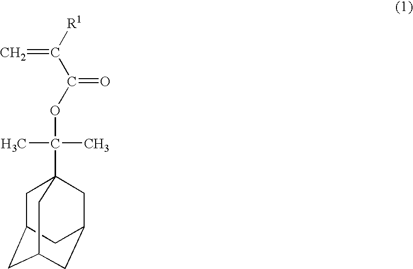
wherein R¹ is a fluorine atom or a fluoroalkyl group; and the adamantane ring in the formula may have a substituent.

2. A process for producing a polymerizable adamantane derivative represented by the following formula (1): 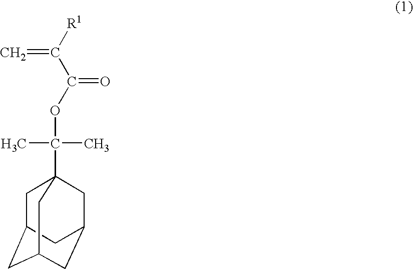
wherein R¹ a fluorine atom or a fluoroalkyl group; and the adamantane ring in the formula may have a substituent, the process comprising the step of allowing a compound represented by the following formula (2): 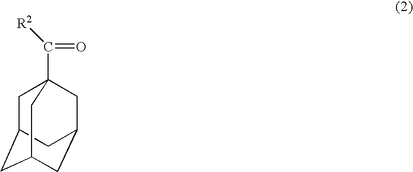
wherein R² is a halogen atom, an alkoxy group, an aryloxy group, an aralkyloxy group, an acyloxy group or a methyl group, and the adamantane ring in the formula may have a substituent, to react with a methylation reagent represented by the following formula (3):
CH₃-M (3)
wherein M is a metal atom or —MgX¹ group, wherein X¹ is a halogen atom, and allowing the resulting reaction product to react with an acyl halide represented by the following formula (4): 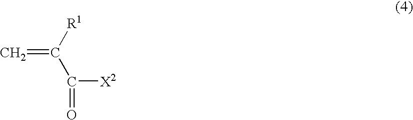
wherein R¹ is the same as defined above; and X² is a halogen atom.

3. A process of producing a polymerizable adamantane derivative represented by the following formula (1): 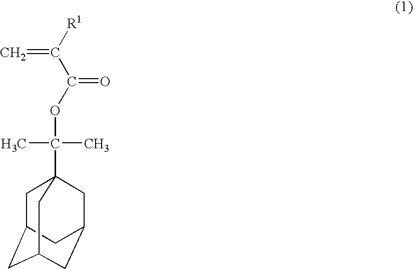
wherein R¹ is a fluorine atom or a fluoroalkyl group; and the adamantane ring in the formula may have a substituent, comprising the step of allowing an adamantane methanol derivative represented by the formula (5): 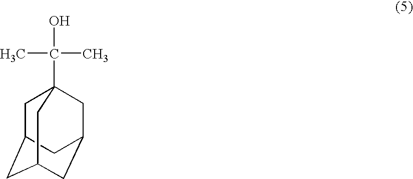
wherein an adamantane ring may have a substituent, to react with an unsaturated carboxylic acid represented by the formula (6): 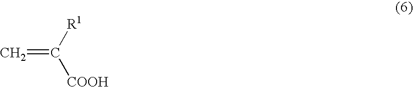
wherein R¹ is the same as defined above, or a reactive derivative thereof.

4. A polymeric compound comprising a repeated unit corresponding to the polymerizable adamantane derivative cited in claim 1.

5. A polymeric compound according to claim 4, further comprising a repeated unit having substrate adhesion function and/or hydrophilicity function.
